(19) United States
(12) Patent Application Publication
(10) Pub. No.: US 2007/0094445 A1
(43) Pub. Date: Apr. 26, 2007

(54) Method to enable fast disk caching and efficient operations on solid state disks

(76) Inventors: Sanjeev N. Trika, Hillsboro, OR (US); Robert W. Faber, Hillsboro, OR (US); Rick Coulson, Portland, OR (US)

Correspondence Address: Lee & Hayes, PLLC;c/o PortfolioIP, P.O. Box 52050, Minneapolis, MN, 55402, US

(21) Appl. No.: 11/254,508

(22) Filed: Oct. 20, 2005

(51) Int. Cl. G06F 13/00

(52) U.S. Cl. 711/113

(57) ABSTRACT

The above-described methods and computer system describe the use of dynamic addressing, lazy relocations and erases, and page state information to provide fast disk caching and solid state disk applications using solid-state nonvolatile memories. The approach reduces write-latencies for demand requests, as well as the number of erase cycles on erase blocks.

### BACKGROUND

Computer systems store data to different types of storage media and devices. Such storage media and devices may be considered nonvolatile, and persistently store data when power to a computer system is turned off. An example of a nonvolatile storage device is a hard disk of a computer system. Storage devices may also include NAND flash memory and solid state disks (SSD). Storage media may include actual discs or platters that are accessed through the storage device. An operating system (OS) executing on a processor may request or perform actions, such as read and write, to particular locations on a storage medium.

Data written to and read from locations in these particular storage devices may be structured in blocks. Bits representing digital information (i.e., 1 or 0) may be grouped as data. In the storage devices, the bits may be stored in cells. Cells may be organized into pages. Therefore, a page is representative of the data. The size of a page typically is about 2,048 bytes for NAND flash memories; however, this is not typical for hard disk drives (HDD). In certain instances, the page may be a different size.

In some non-volatile memories, such as NAND-Flash, pages may be placed into erase blocks. An erase block typically includes about 64 pages, although in certain instances, an erase block may include a different number of pages. In such memories, it is typically required that all pages in a given erase block be erased together rather than individually.

Furthermore, in non-volatile memories such as NAND flash memory, it is typically required that pages are erased before they are written. Erased pages are also sometimes referred to as “blank” or “blank pages”. Thus, only blank pages can be written to. To write to the same page twice, the page is erased after the first write and before the second write. An exception to this rule is that bits in a written page may be toggled from “1” to “0” without an intermediate erase.

When an action such as a write is performed on a page of a storage device or storage medium, the entire erase block containing that page is first read into a temporary location, then the erase block is erased, and all the data is rewritten to the blank pages in the erase block, including the data from the temporary buffer for all but the requested page write, and the new data for the requested page write. Thus, a page write typically requires read, erase, and write operations on the entire erase block containing the page, which is relatively quite slow. The temporary locations may be in volatile memory of the computer system.

The number of erase cycles performed on erase blocks of memory like NAND flash memory may be limited. Typically, it is recommended that such erase actions are performed for no more than 100,000 cycles for each erase block.

Thus, in addition to degradation issues seen at erase blocks from multiple erase cycles, performance issues also exist when performing actions affecting entire erase blocks. Moving pages to and from erase blocks and temporary locations involves significant input/output (IO) traffic in a computer system and uses considerable processor (i.e., controller) resources.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

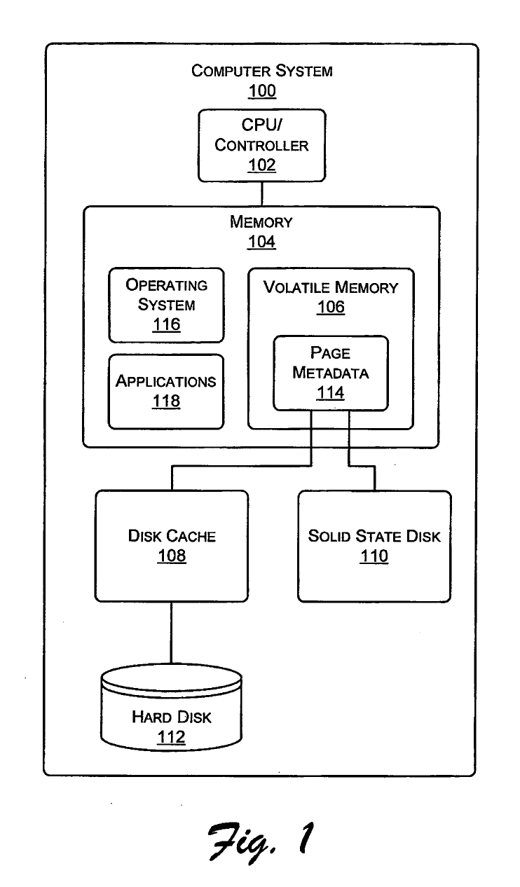

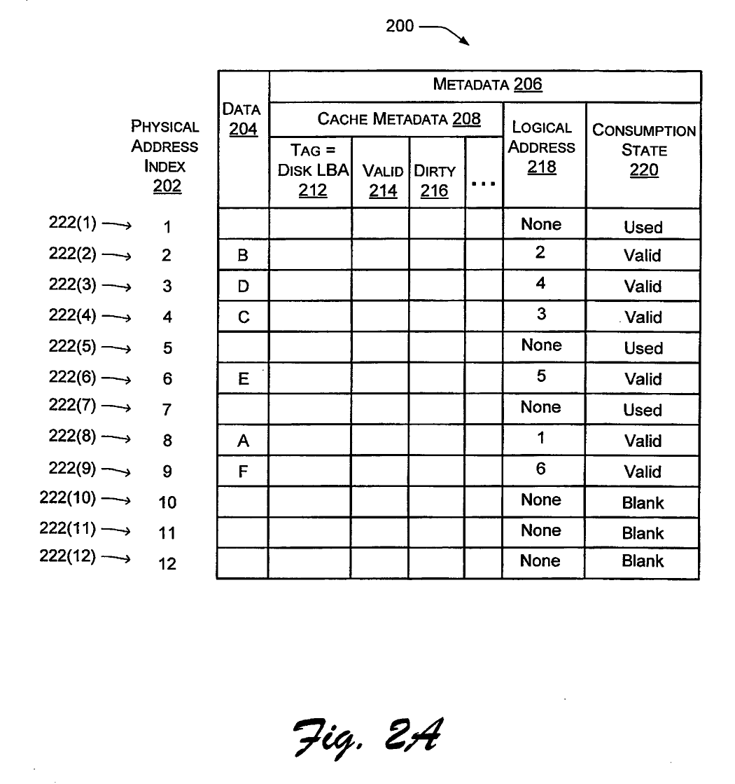

FIG. 1 is a block diagram of a computer system that includes an efficient disk cache and/or a solid state disk.

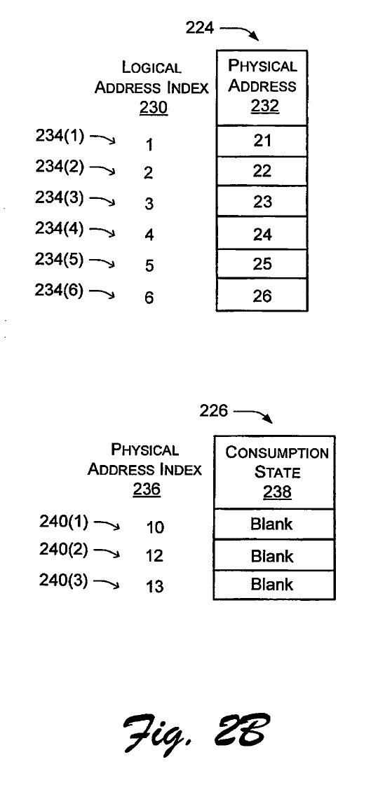

FIG. 2A is a block diagram of page metadata information included in nonvolatile memory of such a disk cache or solid state disk.

FIG. 2B is a block diagram of page metadata information included in volatile memory for controlling such a disk cache or solid state disk.

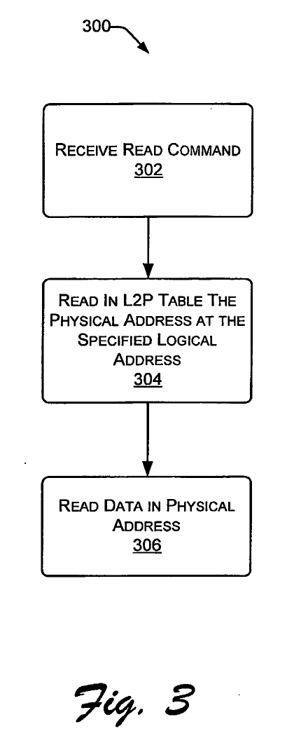

FIG. 3 is a flow diagram illustrating a process for performing a read action to a disk-cache or a SSD.

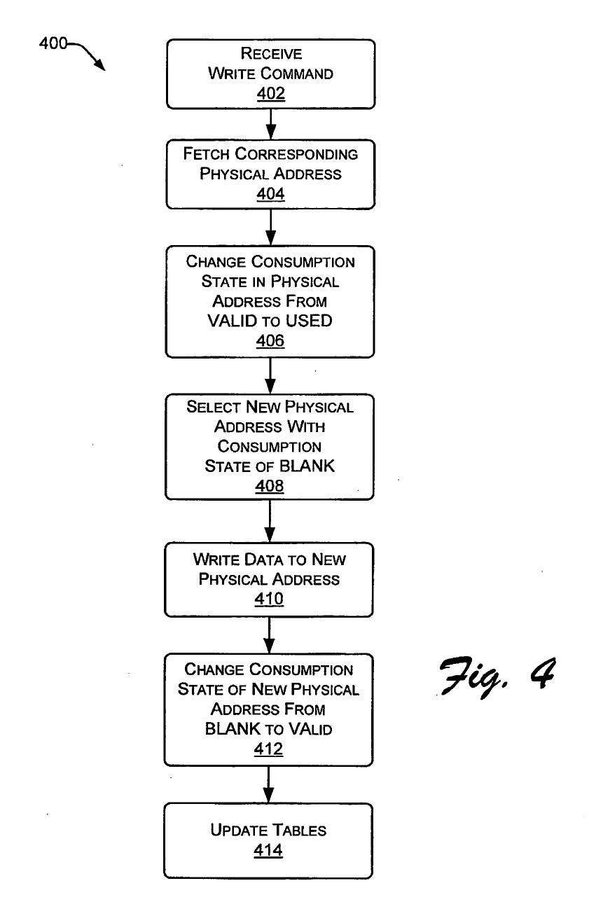

FIG. 4 is a flow diagram illustrating a process for performing a write action to a disk cache or a SSD.

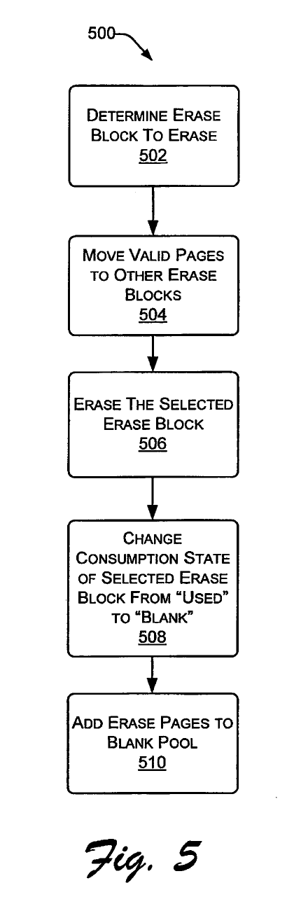

FIG. 5 is a flow diagram illustrating a process for relocating pages in the non-volatile memory based on information provided in page metadata.

### DESCRIPTION OF THE EMBODIMENTS

FIG. 1 illustrates a computer system 100 that provides a disk cache and/or a solid state disk (SSD). Computer system 100 includes one of various devices and systems such as personal computers (PC), laptop computers, and server computers. Computer system 100 may be particularly configured to perform fast or efficient caching (i.e., more efficient operations on storage media) to a storage device or hard disk drive implementing a disk cache. Alternatively, computer system 100 may be configured to include a solid-state drive (SSD) implemented as specified in this application. The particular computer system 100 that is illustrated shows both a disk cache and an SSD. It is contemplated that particular implementations of computer system 100 may have only a disk cache or an SSD, and in certain cases (as illustrated here) both a disk cache and an SSD are implemented. Examples of storage devices include NAND flash memory, NOR flash memory, polymer memory, or any other non-volatile memory organized in erase blocks containing memory pages.

Computer system 100 includes a central processing unit (CPU) or controller 102. In certain embodiments, controller 102 is a dual or multiple processor that includes multiple controllers. Controller 102 may be used for various processes in computer system 100, and particularly may include a memory and disk controller.

A memory 104 is included in computer system 100. The memory 104 is controlled by the controller 102. The memory 104 may include one or more memories such as random access memory (RAM). Memory 104 may include volatile and nonvolatile memory wherein data is lost in volatile memory and data is not lost in nonvolatile memory when computer system 100 is turned off. In this example, memory 104 particularly includes a volatile memory 106. Volatile memory 106 may be dynamic random access memory (DRAM).

Alternatively, the volatile memory 106 may reside in a disk cache 108, or a SSD 110, rather than separate from the disk cache 108 and/or SSD 110. Furthermore, a controller (not shown) may reside inside the disk cache 108 or the SSD 110, or a hard disk drive (HDD) 112. The resident controller particularly controls the volatile and non-volatile memory accesses. In addition, the disk cache 108 may be on a separate bus rather than connected as a filter as shown in the FIG. 1. In particular implementations, disk cache 108 resides in HDD 112.

In this example, volatile memory 106 stores page metadata 114. The page metadata 114 includes consumption state information of the pages (i.e., pages identified by specific physical addresses). The consumption state information includes three states: used, valid, and blank. As further described below, the use of consumption state information allows actions on individual pages to be performed, thereby avoiding the need to erase entire blocks. This enables fast disk caching and solid-state-disk operation by performing actions on individual pages instead of entire erase blocks.

Memory 104 may store an operating system 116 executable by controller 102. Application programs or applications 118 may be stored in memory 104. Applications 118 are run by operating system 116. Operating system 116 is particularly used to perform read and write operations to volatile memory 106 and a storage device such as hard disk 112 and/or SSD 110. Such operations may be performed as a result from requests from applications 118.

Disk cache 108 is included in computer system 100. In implementations where a memory device such as an SSD 110 is used in place of HDD 112, similar logic or processes as performed by disk cache 118 is performed by SSD 110. Data sent to memory 104 (i.e., operating system 116 or applications 118) from HDD 112, goes through disk cache 108 and/or SSD 110.

Disk cache 108 is particularly used for actions performed on HDD 112. For example, a read request is performed by operating system 116. If the data is found in the disk cache 108, the data is sent from disk cache 108 to the operating system 116. If the data is not found in disk cache 108, the data is read from the HDD 112.

If a write action is performed by operating system 116, the data is sent to disk cache 108 and/or to the HDD 112 depending on disk caching logic. During times when the operating system 116 is not active, the data may be sent from the disk cache 108 to the HDD 112.

Information in page metadata 114 includes information as to state of individual pages, and a logical to physical address mapping table, that allows faster disk caching and SSD 110 operations (i.e., more efficient operations) by permitting operations to single pages rather than multiple actions on entire blocks (i.e., erase blocks).

FIG. 2A illustrates layout of data and page metadata in nonvolatile memory such as disk cache 108 or solid state disk (SSD) 110. In particular, table 200 supports what is described as dynamic addressing of nonvolatile memory on a disk cache 108 or a SSD 110. The dynamic addressing continually changes the mapping between the logical addresses and physical addresses to ensure that each logical write operation causes data to be stored in a previously erased location (i.e., at a different physical address) of the nonvolatile memory. Thus, with dynamic addressing, each logical write operation produces a single operation on a page. This is to be compared to typical addressing that use three accesses to the containing erase block of a nonvolatile memory (one to read the data at the erase block containing the specified address, one to erase/invalidate an old erase block, and the third to write the updated data at the erase block).

Table 200 includes a physical address index 202 which indexes a physical address of a physical location in a storage medium or storage device, such as included in disk cache 108 or SSD 110. Table 200 particularly does not include a physical addresses, but accesses physical addresses through physical address index 202. An index points to a physical address, where a physical address defines a particular page in a particular erase block where data is stored.

Table 200 includes a field for data 204 which represents actual data. Table 200 further includes metadata as represented by metadata field 206. Metadata field may include a field cache metadata 208 that describes metadata used by disk cache 108; however, this field may be not required for SSD 110 operation. Included in cache metadata 208 are sub-fields directed to typical prior art cache metadata or application specific metadata, as represented in the following exemplary fields: tag=disk LBA (logical block address) field 212, valid bit field 214, dirty bit field 216, etc. It is well known in the art to include such information or application specific metadata.

A logical address field 218 and a consumption state field 220 are provided in order to allow fast disk caching or efficient SSD operations on storage media. The logical address field 218 represents an address to which the operating system 110, disk cache 118, or logic in an SSD 116 may go for data. In particular, algorithms in disk cache 118 or in SSD 116 refer to logical addresses as defined by the field for logical address 218, in performing the actions to and from the disk cache 108 or SSD 110. The consumption state field 220 represents one of three consumption states of a page. A first consumption state is “blank”, which indicates that data can be written to the page. A second consumption state is “valid”, which indicates that data is present in the page and may be read. A third consumption state is “used”, which indicates that data is present in the page, but it is no longer valid or may not be read. Pages identified as “used” are pages which can be erased. By providing consumption state information for pages, actions (e.g., write or erase) can be performed on pages without having to perform an action on an erase block.

In this example, table 200 includes twelve data entries 222(1) to 222(12) that occupy physical pages 1 to 12, and are indexed by physical address index 202. In specific, data entry 222(1) is indexed by physical address index 1; data entry 222(2) is indexed by physical address index 2; data entry 222(3) is indexed by physical address index 3; and so on.

The pages as defined by their physical address indices may be grouped in erase blocks. For example, pages as defined by indices 1, 2, 3, and 4 are grouped in an erase block 1; pages as defined by indices 5, 6, 7, and 8 are grouped in an erase block 2; and pages as defined by indices addresses 9, 10, 11, and 12 are grouped in an erase block 3. The number of pages and their grouping are for illustration, and it is expected that typical erase blocks will include more than four pages, and that the disk cache 108 and the SSD 110 will include more than three erase blocks

Disk cache 108 or SSD 110 may have a limitation as to a maximum number of logical pages they may address. For example, in this illustration, the maximum may be 6 pages. Therefore, 6 pages in entries 222 can have a consumption state of “valid”. In this example, such entries are entry 222(2), entry 222(3), entry 222(4), entry 222(6), entry 222(8) and entry 222(9). The other entries of entries 222 are either “used” or “blank”.

FIG. 2B illustrates page metadata information in volatile memory such as volatile memory 106. In particular, a logical address to physical address (L2P) table 224, and a blank pool table 226 may be stored in volatile memory 106.

L2P table 224 includes a logical address index field 230 and a physical address field 232. Logical address index field 230 particularly provides an index to a logical address; however, L2P table 224 does not include a logical address. Entries 234 include indexes to logical addresses and corresponding physical addresses.

Blank pool table 226 includes a physical address index field 236 and a consumption state field 238. It is contemplated that for typical implementations, blank pool 236 does not include consumption state field 238, since only physical addresses having a consumption state of “blank” need be identified in blank pool table 226. In other words, the blank pool table 226 is simply a list of physical addresses for which the consumption state is blank in table 220. Each entry of entries 240 include physical addresses (i.e., indices to physical addresses) having a consumption state of “blank”. By identifying available or blank pages, the disk cache 108 or SSD 110 logic can write to particular blank pages. In certain implementations, table 200 may also be included in volatile memory without the data 204 field. In volatile memory, table 200 allows relatively fast and more efficient identification of erase blocks that are mostly empty and required table lookup logic to update the page metadata on relocations.

Since information in table 200 is stored in nonvolatile memory (i.e., disk cache 108 and/or SSD 110), in the event that data is corrupted, erased, or made unavailable (i.e., not kept after power down) in volatile memory 106, data in tables 224 and 226 may be created or recreated using data from table 200. This enables, for example, power-failure recovery for both the disk-caching and the solid-state disk applications despite constantly changing logical-to-physical address mapping, and maintenance of the L2P table 224 in volatile memory.

Exemplary actions of read and write are shown in the next two figures. The processes that are described are illustrated as a collection of blocks in a logical flow graph, which represent a sequence of operations that can be implemented in hardware, software, firmware, or a combination thereof. In the context of software, the blocks represent computer instructions that, when executed by one or more processors, perform the recited operations. The processes are described with reference to computer system 100 and tables 200, 224, and 226 described above. Although described as flow diagrams, it is contemplated that certain processes may take place concurrently or in a different order.

FIG. 3 shows a process 300 for performing a read action to a storage device such as a hard disk or SSD. At block 302, a read command is received. The read command may be received from operating system 116 by disk cache 108 or SSD 110. The read command is particularly directed to data located in a logical address.

At block 304, a physical address is read. The physical address that is read is the corresponding physical address of the logical address of block 302. In particular, the corresponding physical address may be found in an entry in a L2P table such as L2P table 224.

At block 306, the page or data in the page is read. In particular, data located at the physical address read in block 310 is read. The read may be performed by disk cache 108 or SSD 110.

FIG. 4 shows a process 400 for performing a write action to a storage device such as a disk cache or SSD. At block 402, a write command is received. The write command may be received from operating system 110 by disk cache 108 or SSD 110. The write command is particularly directed to data located in a logical address. The logical address is particularly specified by the operating system 106.

At block 404, a corresponding physical address to the logical address is read (fetched) from the L2P table 224. The fetch may be performed by disk cache 108 or SSD 110. This physical address represents the physical page that was previously programmed to contain data at the specified logical address, and is invalidated.

At block 406, the consumption state of the page at this physical address is changed form “valid” to “used”. The change is particularly made in table 200, and can be performed by disk cache 108 or SSD 110. Note that this may be setup as a single bit toggle from “1” to “0”, and thus is an executable operation even on the previously written to page, for non-volatile memories such as NAND Flash.

At block 408, a new physical address is chosen where the new specified data for the given logical address is written. The new physical address is a page that has a consumption state of blank. The new physical address may be chosen from a blank pool such as blank pool table 226. Any number of policies (e.g., FIFO, random, LRU policies) may be used to select a page from the blank pool table 226. The new physical address may be chosen by disk cache 108 or SSD 110.

At block 410, data is written to the page identified in block 408. In particular, the page as identified by the new physical address is written to. Writing the data may be performed by disk cache 108 or SSD 110. Furthermore, table 200 may be updated with both data and metadata at the selected physical address.

At block 412, the consumption state of the new physical address is changed from blank to valid. The change may be particularly reflected in table 200. Disk cache 108 or SSD 110 may perform the change.

At block 414, table 224 is updated to reflect new physical address and logical address relationships. The physical address of the page that was written to in step 410 is removed from the blank pool table 226. These updates may be performed by disk cache 108 or SSD 110. Therefore, the write action affects only two pages (the previous physical address for that logical address, and the new selected page for that logical address), not an entire erase block.

FIG. 5 shows a process 500 which relocates valid pages based on information provided in page metadata, in preparation for erase-block erases that create blank pages that may be later used for fast operations. For instances when computer system 100 and particularly controller 102 are not performing an action on disk cache 108 and/or SSD 110, pages may be relocated and erasures performed on erase blocks. Such instances of “inactivity” may be referred to as “lazy times”. During lazy times, the pages are moved based on consumption state information of the pages found in page metadata 108. Alternatively, a fixed or adaptively set time-threshold may also be used to trigger lazy operations when no operating system issued request has arrived for a time interval greater than this threshold.

At block 502, a determination is made as to which erase block should be erased. A number of policies may be used to select the block for erasure. For example, blocks may be erased in sequential order. Alternatively, the most “used” block (the block containing the most number of used pages) may be selected for erasure. The determination may be made by disk cache 108 or SSD 110, or logic (algorithms) in memory 104.

At block 504, for pages having consumption state of “valid” that are in the erase blocks as determined in block 506, such pages are moved to another erase block or blocks. Updates to tables 200, 224 and 226 are also performed to reflect the move. The move may be performed by disk cache 108 or SSD 110, or logic or algorithms in memory 104.

At block 506, an erase is performed on the erase block that was determined in block 502, since this erase block should now contain only pages having consumption state of “used” or “blank”. Disk cache 108 or SSD 110 may perform the erase.

At block 508, the consumption state of the selected erase blocks are changed from “used” to “blank”. The change of consumption state may be performed by disk cache 108 or SSD 110.

At block 510, the physical addresses of all erased pages are added to the blank pool table 226 for use. Disk cache 108 or SSD 110 may perform adding the erased pages to the blank pool 226.

Process 500 may be repeated as often as necessary to create additional blank pages, for example until a threshold of desired blank pages is reached. Process 500 may also be executed during non “lazy times” when the blank pool 226 falls below a certain threshold.

### CONCLUSION

The above-described methods and computer system describe how to provide fast disk caching and SSDs with non-volatile memories such as NAND Flash, while reducing the number of erase cycles on erase blocks. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A system comprising:
a controller;
a non-volatile storage device; and
a memory controlled by the controller, the memory to store page metadata wherein the page metadata includes consumption states of locations in the non-volatile storage device.

2. The system of claim 1 wherein the page metadata is also stored on the non-volatile storage device.

3. The system of claim 1 wherein the memory comprises a volatile memory and the page metadata is stored in the volatile memory.

4. The system of claim 1 wherein the storage device is one of the following: NAND flash memory, NOR flash memory, polymer memory, or any other solid-state non-volatile memory.

5. The system of claim 1 further comprising logic wherein the non-volatile storage device is a disk cache, and the logic is used for actions performed on the disk cache.

6. The system of claim 1 further comprising logic wherein the non-volatile storage device is a solid-state drive and the logic is used for actions performed on the solid-state drive.

7. The system of claim 1 further comprising a volatile memory, wherein the page metadata is stored in the volatile memory and non-volatile storage device.

8. A method for writing to a logical page comprising:
identifying a first physical address containing the current data of the logical page;
choosing a second physical address having a consumption state of blank;
writing to the second physical address;
changing consumption state of the first physical address from valid to used; and
changing the consumption state of the second physical address from blank to valid.

9. The method of claim 8 wherein the changing the consumption state of a physical address includes updating one or more page metadata tables.

10. The method of claim 9, wherein a blank pool provides available blank addresses that may be used.

11. The method of claim 8 further comprising updating logical address and physical address information in one or more tables.

12. The method of claim 11 wherein the one or more tables includes a logical to physical (L2P) table.

13. The method of claim 8, wherein the method is performed by logic in storage device.

14. A method comprising:
determining a first erase block having one or more pages with a consumption state of used;
moving pages with a consumption state of valid from the first erase block to other erase blocks; and
erasing the first erase block.

15. The method of claim 14 wherein the method is performed during instances of operating system inactivity of input or output.

16. The method of claim 15 wherein the instances is determined base on a time threshold.

17. The method of claim 14 wherein the moving comprises updating tables that include page metadata.

18. The method of claim 14, wherein the method is performed by logic in storage device.

19. The method of claim 14 further comprising changing the consumption state of the first erase block to blank.

20. A method comprising:
recovering logical and physical address (L2P) information of pages of a storage device from nonvolatile memory of the storage device; and
creating a logical to physical table (L2P table) in a volatile memory.

21. The method of claim 20 wherein the method is performed during recovery after an abnormal shutdown of a computer system.

22. The method of claim 21 wherein the abnormal shutdown is a power failure.

23. The method of claim 21 wherein the abnormal shutdown is a system crash.

24. The method of claim 20 further comprising recovering a blank pool table of the storage device from the nonvolatile memory and creating a blank pool in the volatile memory.

25. The method of claim 21 further comprising reconstructing the L2P table after the abnormal shutdown.

26. The method of claim 20, wherein the method is performed by logic in storage device.
